(19) United States
(12) Patent Application Publication
(10) Pub. No.: US 2012/0285986 A1
(43) Pub. Date: Nov. 15, 2012

(54) SYSTEM AND METHOD FOR CUSTOMIZED BEVERAGES

(76) Inventor: JASON BRADLEY IRVIN, Mesa, AZ (US)

(21) Appl. No.: 13/359,483

(22) Filed: Jan. 26, 2012

Related U.S. Application Data
(60) Provisional application No. 61/436,470, filed on Jan. 26, 2011.

(51) Int. Cl. A47J 31/00; G06F 15/16; B67D 7/24

(52) U.S. Cl. 222/1; 709/217; 222/30

(57) ABSTRACT

A system for the automated preparation and delivery of customized beverages is disclosed. The system is deployed as a kiosk or similar device and provides an automated user-customizable drink purchasing experience. The user can select the desired base, add-in ingredients, etc. and receive a drink that has been prepared in accordance with the user preferences. In addition, individual and aggregate user preferences and purchasing habits (e.g., quantity and type of drink purchased, frequency of purchases, location of purchases, etc.) can be tracked, stored, and used to provide targeted marketing messages, including special discounts, promotions, etc.

### RELATED APPLICATIONS

This patent application claims priority to U.S. Provisional Patent Application No. 61/436,470, which application was filed on Jan. 26, 2011, and which application is incorporated herein by reference.

### BACKGROUND OF THE INVENTION

1. Technical Field

The present invention relates generally to the field of beverages and more specifically relates to equipment and methods for creating customized drinks

2. Background Art

Beverage consumption is an important part of daily living. Humans must consume adequate quantities of proper liquids every day in order to maintain health, fitness, and quality of life. In the fast-paced world faced by many people today, convenience and quality of the beverages consumed have become increasingly important. Water bottles, juice packs, canned beverages, etc. have become increasingly prevalent and popular throughout the world. Additionally, the ever-expanding number of beverage choices continues unabated as develop and introduce new beverages by the score every year.

With the growth of more beverage choices, custom made drinks have blossomed into big business. Choice is increasingly important to the beverage consumer and there are now many different ways for people to get a drink made just the way that they like it. For example, many businesses such as Starbucks®, Jamba Juice®, Planet Smoothie®, and others have become very popular in recent years by providing on demand “made to order” drinks In addition to these large-scale national franchise operations, many smaller locations such as snack bars, gyms, universities, etc. now offer bars or counters where their customers can order various customized energy drinks and smoothies. Home brewed coffee, teas, and standard canned or bottled beverages, while still popular, have steadily yielded ground to the incredible growth of “designer” custom or personalized beverages.

Some of the more popular retail beverage locations will provide a beverage consumer with the option of selecting a “base” liquid (e.g., milk, fruit juice, vegetable juice, etc.) and then water or ice may be added to achieve the desired consistency and volume for the beverage. Additionally, many locations will provide the beverage consumer with the option to add in fruit or vegetables and other types of ingredients, commonly known as “boosters” or “add-ins,” etc. Some of the more commonly used boosters include vitamins, minerals, fiber, and herbs that are believed to provide the beverage consumer with the desired balance of ingredients for a delicious and healthy beverage. Eventually, all of these ingredients are placed into a mixer or blender, blended together, and then delivered to the beverage consumer for consumption.

While these various custom beverage providers have been somewhat successful, the present custom beverage business model is not without certain drawbacks. For example, since the custom beverage provider must have a physical location from which to dispense the custom beverages, a retail storefront or beverage kiosk must be purchased or leased. Additionally, since the beverage consumer is seeking a customized drink experience, staff (e.g., “baristas”) must be available to interact with the beverage consumer to take and prepare the order for the beverage consumer to drink. Further, the cost of the customized beverages is increasing every year, driven by inflation and the related growth in overhead costs. The more options available to the beverage consumer, the more costly and time-consuming the drink preparation process can become since the additional variations tend to add complexity in the preparation and delivery of the drinks.

Additionally, since the availability and quality of the custom beverage is highly dependent on the location of the consumer and the ingredients used by the provider, overall satisfaction with the final product can vary widely and consistency may be an issue even at the same location, depending on the skill of the beverage preparer. While customized drinks are highly desired by the beverage consuming public, these, and other impediments have continually slowed the more rapid spread and adoption of various custom beverage options. Accordingly, without additional improvements in the current systems, products, and methods for creating and delivering customized drinks such as smoothies, the overall process and user experience will continue to be sub-optimal.

### BRIEF SUMMARY OF THE INVENTION

A system for the automated preparation and delivery of customized beverages is disclosed. The system is deployed as a kiosk or similar device and provides an automated user-customizable drink purchasing experience. The user can select the desired base, add-in ingredients, etc. and receive a drink that has been prepared in accordance with the user preferences. In addition, individual and aggregate user preferences and purchasing habits (e.g., quantity and type of drink purchased, frequency of purchases, location of purchases, etc.) can be tracked, stored, and used to provide targeted marketing messages, including special discounts, promotions, etc.

### BRIEF DESCRIPTION OF THE FIGURES

The preferred embodiments of the present invention will hereinafter be described in conjunction with the appended drawings, wherein like designations denote like elements, and:

FIG. 1 is a front elevation view of a custom beverage dispensing system in accordance with a preferred exemplary embodiment of the present invention;

FIG. 2 is a cross-sectional view taken on line 2-2 of FIG. 1;

FIG. 3 is a top plan view of a plurality of carousels suitable for use in conjunction with a custom beverage dispensing system in accordance with a preferred exemplary embodiment of the present invention.

FIG. 4 is a front elevation view of the carousels of FIG. 3;

FIG. 5 is a perspective view of a hopper suitable for use in conjunction with a custom beverage dispensing system in accordance with a preferred exemplary embodiment of the present invention;

FIG. 6 is a block diagram of a custom beverage dispensing system deployed in a network environment in accordance with a preferred exemplary embodiment of the present;

FIG. 7 is a block diagram of a data server suitable for use in accordance with a preferred exemplary embodiment of the present;

FIG. 8 is a view of a front panel suitable for a custom beverage dispensing machines used in conjunction with a custom beverage dispensing system in accordance with an alternative preferred exemplary embodiment of the present invention; and

FIG. 9 is a flow chart of a method for dispensing custom beverages in accordance with a preferred exemplary embodiment of the present invention.

### DETAILED DESCRIPTION OF THE INVENTION

A system for the automated preparation and delivery of customized beverages is disclosed. The system is most preferably deployed as a kiosk or similar device and provides an automated user-customizable drink purchasing experience. The user can select the desired base, add-in ingredients, etc. and receive a drink that has been prepared in accordance with the user preferences. In addition, individual and aggregate user preferences and purchasing habits (e.g., quantity and type of drinks purchased, frequency of purchases, location of purchases, etc.) can be tracked, stored, and used to provide targeted marketing messages, including special discounts, promotions, etc.

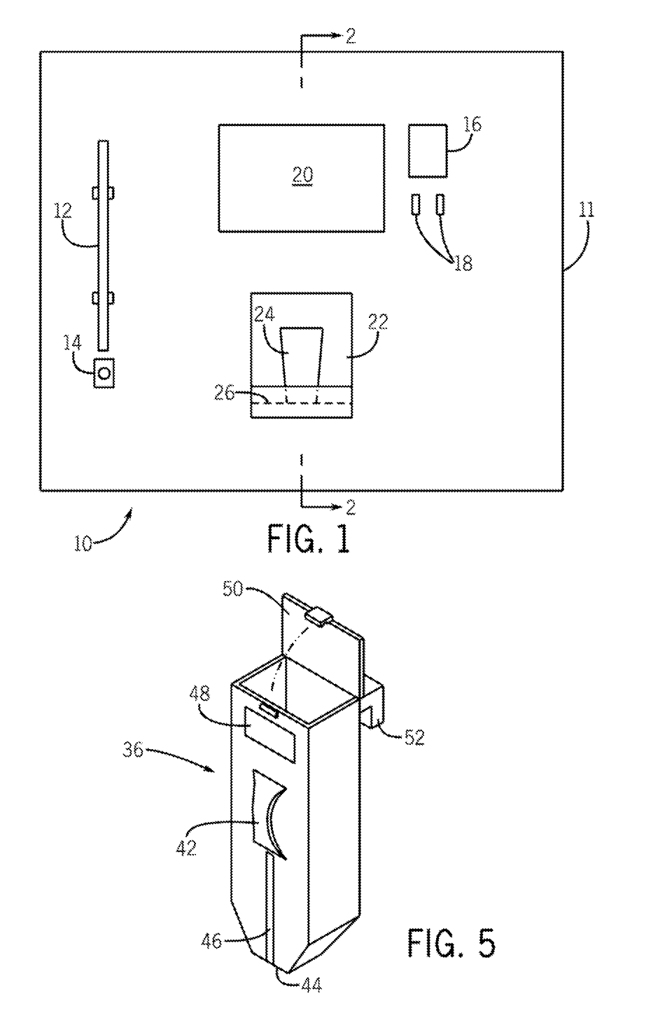

Referring now to FIG. 1, a custom beverage dispensing machine 10 in accordance with a preferred exemplary embodiment of the present invention comprises: a housing 11; a handle 12; a lock 14; a fingerprint identification pad 16; at least one universal serial bus (“USB”) port 18; a touchscreen 20; an access opening 22; a beverage cup 24; and a cup conveyor 26. Although depicted herein as a fairly standard size and shape, it should be noted that custom beverage-dispensing machine 10 may be manufactured and deployed in various sizes and shapes. For example, free standing machines and countertop machines may be deployed for different locations.

Housing 11 encloses all of the devices and ingredients used to create the custom beverages. This includes hoppers and metered dispensing units for dispensing precise portions of liquids and powders that are used to create the custom beverages dispensed by custom beverage dispensing machine 10. Housing 11 may be manufactured from any suitable material known to those skilled in the art for similar machines (e.g., vending machines for candy bars, soft drinks, etc.).

For the most preferred embodiments of the present invention, housing 11 also contains an internal cooling system and the refrigerant are necessary to keep the ingredients stored at desired temperatures. In at least some embodiments of the present invention, a heat source may be included in order to prepare and deliver hot drinks to the beverage consumer.

Handle 12 is provided as a means to open housing 11 so as to access the interior components of custom beverage dispensing machine 10. Handle 12 may be of any design or style so as to accomplish the purpose described herein.

Lock 14 is any type of locking mechanism that can be suitably deployed so as to secure custom beverage dispensing machine 10 so that unauthorized persons cannot tamper with the components and ingredients housed inside housing 11.

Fingerprint identification pad 16 is a touch sensitive pad that is used to identify the beverage consumer. When the beverage consumer places their thumb or index finger on fingerprint identification pad 16, custom beverage dispensing machine 10 can uniquely identify the beverage consumer. In the most preferred embodiments of the present invention, each user will have a user account and the user's preferences as to customized drinks will be stored. Additionally, in some embodiments of the present invention, each user will have an account balance associated with their user account.

Whenever the user activates custom beverage dispensing machine 10 by placing their finger on fingerprint identification pad 16, their account balance can be accessed and updated to subtract the cost of the customized beverage from the account balance associated with their user account. This will allow the beverage consumer to “purchase” customized beverages without inserting any money into custom beverage dispensing machine 10. Alternatively or, in addition, the beverage consumer may interact with touchscreen 20 to identify himself or herself to procure customized drinks.

In the most preferred embodiments of the present invention, at least one universal serial bus (“USB”) port 18; will be included in housing 11 of custom beverage dispensing machine 10. USB ports 18 will be used to selectively upload or download information from a hand held device (e.g. cellular telephone, MP3 player, etc.). For example, while a customized beverage is being prepared by custom beverage dispensing machine 10, the beverage consumer can view short paid advertising clips and/or positive images and videos. This may include still or video displays of standard gym exercises, sport specific exercises, nutritional and food preparation/diet advice, and video clips associated with professional athletes as well as content related to an athletes sport, such as MLB, NFL, NBA, etc. Beverage users will also have the opportunity to save the video clips, educational material to their account and/or save to an external device via USB port 18.

Touchscreen 20 is most preferably a liquid crystal display (“LCD”) or other similar type of touch sensitive screen, suitable for displaying a user interface that provides the beverage consumer with a means to interact with custom beverage dispensing machine 10 to order and receive customized beverages. In addition to fingerprint pad 16, a beverage consumer can “log into” their user account right at custom beverage dispensing machine 10. Each beverage consumer will have a unique identification name or number, and associated password or pass phrase that will allow them to interact with custom beverage dispensing machine 10 to order and receive customized beverages.

Once the beverage consumer has activated custom beverage dispensing machine 10, touchscreen 20 will provide a menu of choices from which the beverage consumer may select their desired beverage. The menu choices will include preconfigured drink options, previously selected customized beverages created by the beverage consumer at an earlier point in time, and “ad-hoc” selections where the beverage consumer may create a completely customized beverage by selecting the desired ingredients. Once the beverage consumer has finalized their selection, they will be able to store the selection and associate it with their user account. This will allow the beverage consumer to select this same customized beverage at another time.

Beverage consumers will be able to interact with touchscreen 20 to order customized beverages from custom beverage dispensing machine 10. The beverage consumer can select their desired drink and customize their drink by selecting or excluding certain ingredients from their customized beverage. All of the options for creating customized beverages will be displayed on touchscreen 20.

Access opening 22 is an opening in housing 11 where the customized beverage, contained in beverage cup 24, will be delivered to the beverage consumer.

Beverage cup 24 is any type of cup used to hold and provide beverages for consumption by the beverage consumer. In the most preferred embodiments of the present invention, beverage cup 24 is a lightweight, disposable container that is stable yet inexpensive. It is anticipated that beverage cup 24 will be manufactured from plastic and/or paper materials but will be sturdy enough to withstand having the contents of cup 24 blended together with a mixer.

Cup conveyor 26 is part of a conveyance system that is contained within housing 11 and that is used to transport a plurality of beverage cups 24 from the interior of housing 11 to access opening 22, where the customized beverage contained in each beverage cup 24 may be accessed by the beverage consumer.

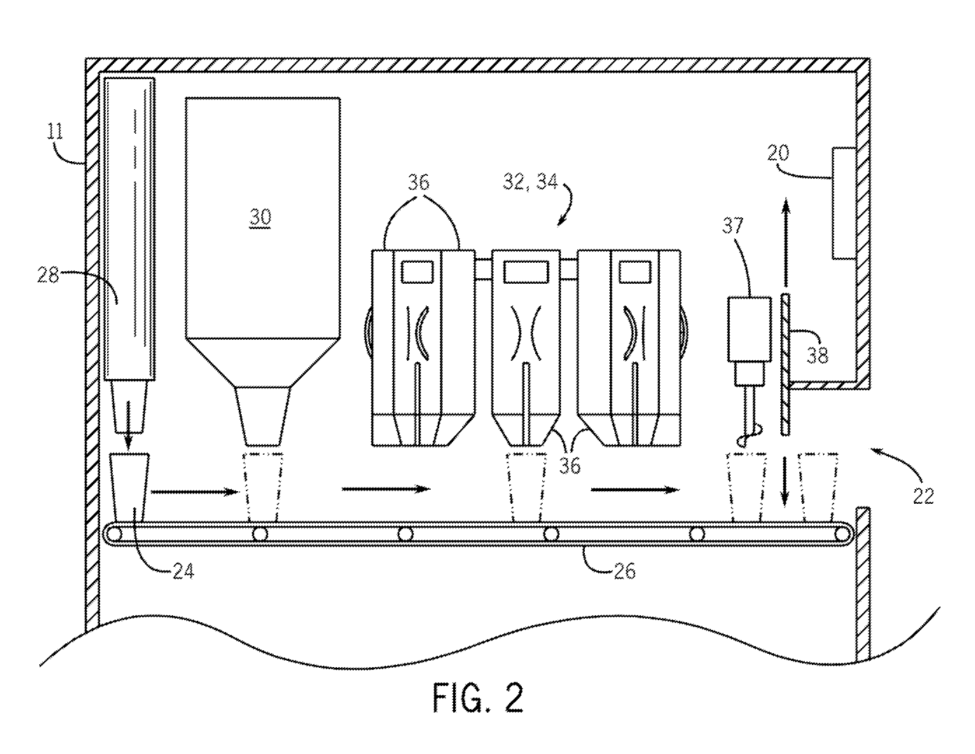

Referring now to FIG. 2, a portion of the interior of custom beverage dispensing machine 10 is depicted. As shown in FIG. 2, cup dispenser 28 is designed to hold a plurality of cups 24. Cups 24 will be placed on conveyor 26 and moved from station to station inside custom beverage dispensing machine 10. For iced drinks, ice will be dispensed from ice hopper 30 into cup 24. Next, cup 24 will be positioned beneath one or more ingredient hoppers 36. Each ingredient hopper 36 will be actuated and controlled by a software program that will programmatically dispense the appropriate ingredient, in the appropriate amount, based on the selections made by the beverage consumer while interacting with touchscreen 20 of FIG. 1.

Ingredient hoppers 36 may contain liquid or powdered ingredients. For example, water, yogurt powders, powdered milk, herbal supplements, vitamins, protein powder, liquid peanut butter, powdered fruit juice, etc. may all be stored in one or more ingredient hopper 36. In the most preferred embodiments of the present invention, there will be a minimum of 16 ingredient hoppers 36, with each ingredient hopper 36 containing a different ingredient. Ingredient hoppers 36 will be affixed to one or more rotating carousels 32 and 34. In this fashion, each ingredient hopper 36 can be rotated into position to dispense the proper ingredient into cup 24 to create the appropriate customized beverage. In at least one preferred embodiment of the present invention, frozen ingredients and alcohol may be stored in an ingredient hopper 36. In another preferred embodiment of the present invention, ingredient hoppers 36 will be configured to dispense hot drinks (e.g., coffee, hot chocolate, etc.).

The specific combination of ingredients stored in ingredient hoppers 36 will be selected based on the specific location of each custom beverage-dispensing machine 10. For example, at a gym or athletic training facility, the contents of ingredient hoppers 36 will typically include options that would be appropriate for sports related activities while at a night club or other entertainment facility, different ingredients may be selected.

The contents of ingredient hoppers 36 may be restocked by an operator who will visit each custom beverage dispensing machine 10 on his or her route on a regular basis to resupply each custom beverage dispensing machine 10 and ensure proper operating conditions for the custom beverage dispensing machine 10. In at least one preferred embodiment of the present invention, a dedicated water supply line (not shown this FIG.) will be positioned inside custom beverage dispensing machine 10 to provide for a supply of filtered water which may be used for mixing customized beverages or cleaning the interior components of custom beverage dispensing machine 10.

Additionally, in the most preferred embodiments of the present invention, once a given ingredient hopper 36 reaches a “low” supply level, custom beverage dispensing machine 10 will send a alert signal to a centralized location to provide notice that it is necessary to resupply the ingredient hopper 36. If, at any time, a particular ingredient is needed for a specific customized beverage but is not available to an out of supply condition, custom beverage dispensing machine 10 will remove all drinks that utilize that specific ingredient from the menu of choices until such time as the ingredient has been restocked in the appropriate ingredient hopper 36.

Once all of the appropriate ingredients have been dispensed from the appropriate ingredient hoppers 36, cup 24 will be moved to a mixing location where a mixer 37 will blend all of the ingredients in cup 24 to create a customized beverage will then be moved to a dispensing location outside of housing 11 by opening door 38, where the customized beverage will be dispensed at access opening 22. Mixer 37 is mounted so as to move in a vertical direction, being lowered into position to engage the contents of cup 24, and then being raised into its original position so as to provide passage for cup 24 to the beverage consumer at the exterior of custom beverage dispensing machine 10. Finally, the interior of custom beverage dispensing machine 10 will also contain a disinfectant/washing system for cleaning the interior components after use. All components are water tight, allowing for a spray system to introduce hot water and cleaning solutions into custom beverage dispensing machine 10, to maintain a clean and healthy environment.

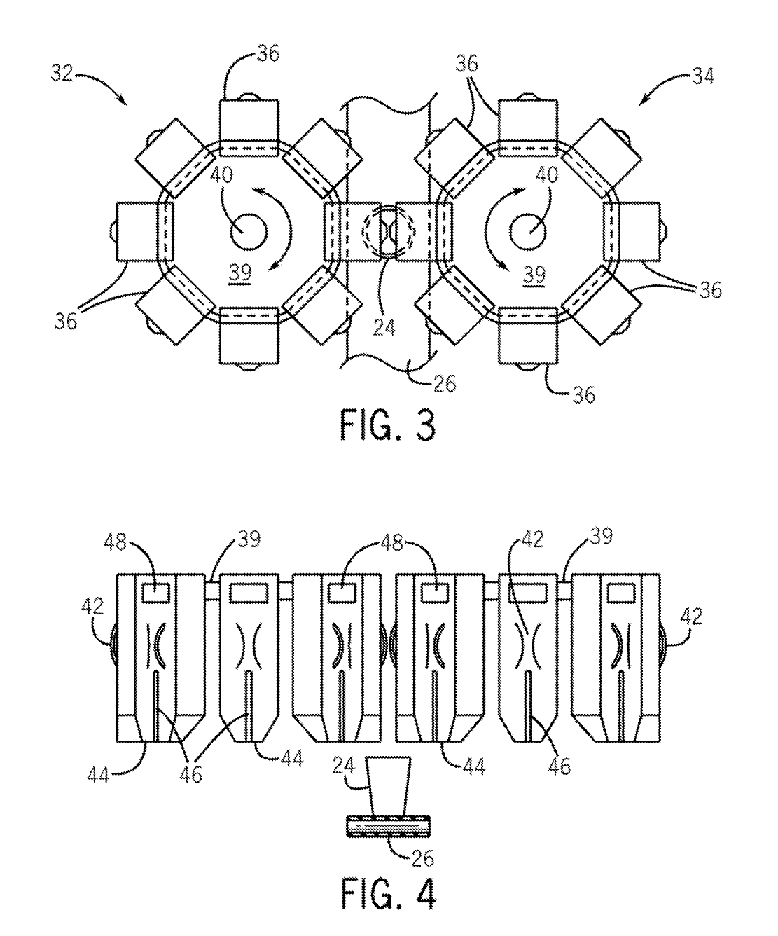

Referring now to FIG. 3, top plan view of a carousel 32 and a carousel 34 suitable for use in conjunction with a preferred exemplary embodiment of custom beverage dispensing machine 10. As shown in FIG. 3, a plurality of ingredient hoppers 36 are affixed to a base 39 for each of carousel 32 and a carousel 34. Each of carousel 32 and carousel 34 is configured to rotate about a central shaft 40 allowing for the dispensing of the contents of each ingredient hopper 36 into a cup 24 as it is positioned by conveyor 26.

Referring now to FIG. 4, an elevation view of carousel 32 and carousel 34 is depicted. As shown in FIG. 4, each ingredient hopper 36 is attached to a base 39. Additionally, each ingredient hopper 36 comprises a handle 42 that allows each individual ingredient hopper 36 to be removed from carousel 32 or carousel 34 to be cleaned or refilled with the appropriate ingredient. Each ingredient hopper 36 also comprises a dispensing outlet 44, a sight window 46, and a label surface 48. Dispenser outlet 44 is where the contents of each ingredient hopper 36 is dispensed. Sight window 46 is a clear portion of the exterior housing of each ingredient hopper 36 that allows for a visual indication as to the level of product remaining inside a given ingredient hopper 36. Label surface 48 provides a location where indicia describing the contents of each ingredient hopper 36 can be displayed.

Referring now to FIG. 5, an individual ingredient hopper 36 is depicted. As shown in FIG. 3, each ingredient hopper 36 comprises a lid 50 that can be selectively opened and closed, thereby providing access to the interior of ingredient hopper 36. This is useful for adding ingredients into hopper 36. Each ingredient hopper 36 also comprises an attachment hook 52 that allows ingredient hopper 36 to be attached to carousel 32 or carousel 34 as shown in FIG. 3.

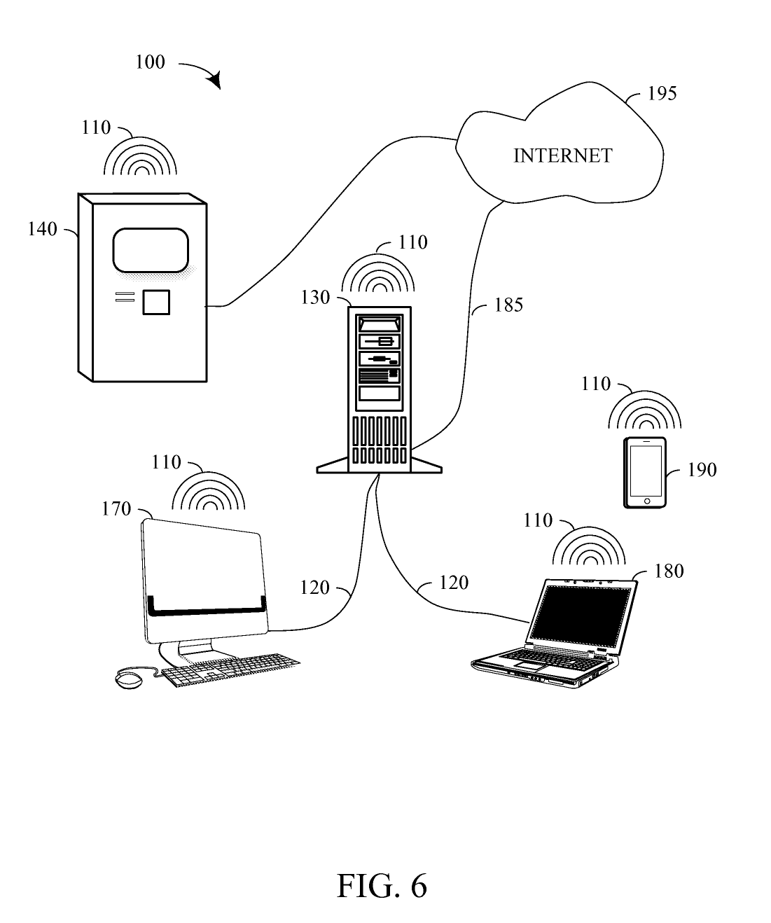

Referring now to FIG. 6, a network connected system 100 for providing customized beverages in accordance with a first preferred exemplary embodiment of the present invention comprises: a custom beverage dispensing machine 140; a data server 130; at least one of a desktop computer 170 and a laptop computer 180; and a smartphone or Personal Digital Assistant (“PDA”) 190 all connected or coupled via a network 120 to the Internet 195 via a wireless connection or a wired connection 185.

Taken together, the components of networked beverage system 100 provide a platform for creating and delivering customized beverages to users of custom beverage dispensing machine 140, as well as providing a facility for tracking and monitoring user data and related sales data (e.g., time and date of sale, number and type of drinks sold, supply levels of ingredients inside beverage dispensing machine 140, etc.). Networked beverage system 100 provides a mechanism for beverage consumers and beverage suppliers to efficiently and effectively track, store, monitor, and report the occurrence of various events related to the preparation, delivery, and consumption of customized beverages, as well as the results of events. This allows all participants to make decisions and take actions based upon the occurrence of the events.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard wireless connection 110 or a wired connection 185 between the various components of networked beverage system 100 for providing access to additional network resources and other remote locations. Network 120 provides for communication between the various components of networked beverage system 100 and allows for relevant information to be transmitted from device to device. In this fashion, a user of networked beverage system 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of both audio and video data and signals and comprises at least a connection 185 for transmission of data.

In addition to the other components shown in FIG. 6, a wireless communication access device may be communicatively coupled to network 120 and may be type any wireless communication mechanism that is known to those skilled in the art to provide for wireless communication between network 120 and the various devices associated with network 120, including desktop computer 170, laptop computer 180 as well as a smart phone 190. The most preferred embodiments of an acceptable wireless communication access device may comprise any type of wireless bridge, wireless router, or similar type of device (not shown this FIG.).

Regardless of the specific components, physical nature, and topology, network 120 serves to logically and communicatively link the physical components of networked beverage system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively computer system that is made available to desktop computer 170, laptop computer 180, and/or phone 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with networked beverage system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN or WAN and has access to one or more additional data servers (not shown this FIG.).

Similarly, laptop computer 180 may be any type of relatively lightweight portable computer system known to those skilled in the art that is capable of being configured for use with networked beverage system 100 as described herein. This includes tablet computers (e.g., iPad®), pen-based computers and the like. Computer 180 may also be configured to allow the transmission and reception of audio signals, messages, and alerts via server 130 and network 120.

Additionally, netbooks, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with tracking, monitoring and reporting information regarding certain ad-hoc and pre-determined events related to the preparation and consumption of beverages. The users of desktop computer 170 and/or laptop computer 180 may be beverage consumers or the owners/operators of networked beverage system 100.

It should be noted that while FIG. 6 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 to access data server 130 and create, update or otherwise modify a given database. An operator, located in a remote location, may use desktop computer 170 or laptop computer 180 to access data server 130 to retrieve information about the persons and events being tracked by the users of networked beverage system 100. Additionally, beverage consumers may also access user account related data from data server 130 in order to enhance their beverage consumption options. This may include “pre-loading” their account balance by transferring money into their user account. Then, when they next desire to purchase a customized beverage from

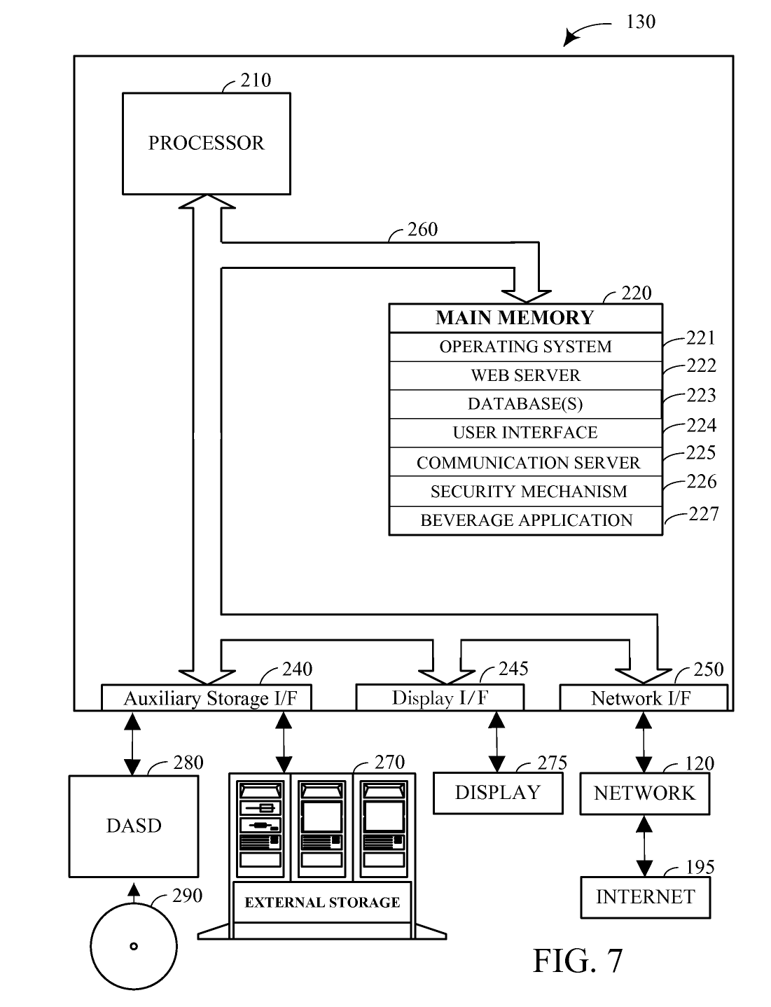

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (“ASP”), “cloud,” or Software As A Service (“SAAS”) environment where data server 130 may be operated as a clearinghouse in a hosted operation. In this fashion, multiple desktop computers 170 and laptop computers 180 will have access to data server 130 and the databases stored thereon via a global computer network such as Internet 195. Data server 130 is further described below in conjunction with FIG. 7 below.

An optional printer and an optional fax machine (not shown this FIG.) may also be deployed for various hard copy data output requirements and may be considered to be any standard peripheral devices used for transmitting or outputting paper-based documents, notes, transaction details, receipts, etc. in conjunction with the various requests and transactions processed by networked beverage system 100 (e.g., reports, statistical analyses, automated letters, etc.) Finally, it should be noted that the optional printer and the optional fax machine are merely representative of the many types of peripherals that may be utilized in conjunction with networked beverage system 100. It is anticipated that other similar peripheral devices will be deployed in the various preferred embodiment of the present invention and no such device is excluded by its omission in FIG. 6.

Smartphone 190 is representative of any type of cellular device or telephone that may be communicatively coupled to networked beverage system 100. This includes, for example, personal digital assistants (“PDAs”), Windows® mobile devices, Palm® OS devices, Pocket PC® devices, the Apple® iPhone® and iPad® and other various types of smartphones. Those skilled in the art will recognize these various devices and others that are suitable for deployment as phone 190. While somewhat less powerful than computers 170 and 180, smartphone 190 may also be configured to wirelessly communicate with data server 130 via network 120 to send and retrieve tracking and messaging services related information to and from data server 130.

Given the standard functionality for devices that may be deployed as phone 190, this communication be provided by a wireless Internet connection (e.g. “wi-fi” or “wi-max”) or a Bluetooth® connection. One example of the use for smartphone or PDA 190 in the context of networked beverage system 100 would to check the account balance or to update a user account. This may be accomplished via a native “app” or by accessing a web browser interface to the “cloud” service described above.

Those skilled in the art will recognize that FIG. 6 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of networked beverage system 100.

Referring now to FIG. 7, a data server 130 of FIG. 6 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 7 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

Display interface 245 is used to directly connect one or more displays 275 to data server 130. Display 275, which may be non-intelligent (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and networked beverage system 100, including computer 170 and computer 180 of FIG. 6. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

Main memory 220 suitably contains an operating system 221, a web server 222, one or more databases 223, a user interface 224, a communication server 225, a security mechanism 226, and an event mechanism 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with graphical user interface 224, including via network 120 of FIG. 6.

Database 223 is representative of any suitable database known to those skilled in the art. In the most preferred embodiments of the present invention, database 223 is a Structured Query Language (SQL) compatible database file capable of storing information relative to various items that may be of interest to the users of networked beverage system 100 of FIG. 6. In the most preferred embodiments of the present invention, database 223 will comprise a plurality of information that may be useful to an organization or individual that wants to perform beverage consumption related event tracking and reporting activities in conjunction with a preferred embodiment of networked beverage system 100 of FIG. 6.

User interface 224 is a software component that provides the users of networked beverage system 100 of FIG. 6 a means for interacting with the various components of networked beverage system 100. In the most preferred embodiments of the present invention, graphical user interface 224 is a web browser based interface, accessible to the users of networked beverage system 100 via any standard web browser from any computer that is connected to the Internet. It may also provide an interface for a mobile device “app” for certain functions. In any case, user interface 224 will interact with beverage application 227 to pass data to and from database 223, and to and from beverage consumers as they interact with networked beverage system 100 of FIG. 6.

In a preferred embodiment of the present invention adapted for use in providing custom beverages to beverage consumers, database 223 will typically include a plurality of database records containing information about multiple beverage consumers and custom beverage dispensing machines 140 (e.g., machine location, beverage consumer names, favorite drinks, location, dates and times of beverage consumption, etc.) and specific situation/circumstances related to beverage dispensing and consumption (e.g., operational status of machines, level of supplies in each machine, etc.) as well as information providing for tracking, analyzing and reporting information that may be used to provide various services to the users of networked beverage system 100 of FIG. 6.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of networked beverage system 100 of FIG. 6 will typically include a communication server 225 in main memory 220. Communication server 225 is an automated programmable system that is capable of generating one or more forms of messages or message events. For example, communication server 225 may be configured to send automated email messages or SMS messages to cell phones. Communication server 225 may also be used to generate hard copy messages (e.g., mail merge letters) that are then sent via standard U.S. Postal Service or some type of commercial message delivery company.

Additionally, communication server 225 may be configured to generate a facsimile message by utilizing fax server and a facsimile modem (not shown this FIG.) that is contained in data server 130 of FIG. 7. Communication server 225 is also capable of being configured and used to send and receive various electronic status messages (e.g. audio and video alerts) and updates to data server 130 and between computers 170, 180, and/or 190 of FIG. 6, as may be necessary to enhance the overall process of completing activities related to the provision of event tracking and reporting services as described herein. This includes the generation of automated email status updates, marketing messages and informational messages related to beverage consumers and their accounts, etc.

In addition, most preferred embodiments of the present invention will include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of networked beverage system 100 of FIG. 1, thereby enhancing the robustness of networked beverage system 100 of FIG. 1. Security mechanism 226 is most preferably configured to protect the integrity and security of the information transmitted via network 120 of FIG. 6.

Further, depending on the type and quantity of information stored in database 223 and accessed by graphical user interface 224, security mechanism 226 may provide different levels of security and/or encryption for different computer systems 170 and 180 of FIG. 6 and the information stored in database 223. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like. These features and other similar features known to those skilled in the art will provide security for user account information (e.g., credit card information, address, phone numbers, etc.).

Beverage application 227 is a software mechanism that interacts with all other components of networked beverage system 100 to create and manage the operation of networked beverage system 100. Each and every transaction related to custom beverage dispensing machine 140 and each beverage consumer that is connected to networked beverage system 100 is tracked and recorded by beverage application 227 for efficiency and effectiveness.

For example, a beverage consumer may create customized drink profiles by accessing their user account, stored in database 223. This event will be tracked and recorded by beverage application 227. Using a smartphone app, the beverage consumer may access database 223 and find the location of a custom beverage-dispensing machine 140 in their immediate vicinity. The beverage consumer may also add money to their account balance via credit card or wire transfer. This allows the beverage consumer to replenish their account balance at any time.

The owners/operators of networked beverage system 100 will be able to access beverage application 227 to more effectively manage networked beverage system 100. Since every custom drink that is dispensed by a custom beverage dispensing machine 140 is tracked and recorded, there will be a significant increase in the operational efficiency of networked beverage system 100 track and monitor the performance of each custom beverage dispensing machine 140 in networked beverage system 100, thereby allowing them to decide what custom beverages are most popular and which custom beverage dispensing machines 140 need service or restocking They will be able to track daily, weekly, and monthly sales data on a machine-by-machine basis or on an aggregated basis.

In the most preferred embodiments of the present invention, the various components of networked beverage system 100 of FIG. 6 are able to communicate using multiple communications protocols and systems (e.g., Voice over IP or “VoIP”, Plain Old Telephone Service or “POTS”, etc.). Those skilled in the art will recognize that the communication protocols used herein may be readily adapted and configured to allow for the rapid and efficient transmission and receipt of data by and between the various components of networked beverage system 100 of FIG. 6. This would also include the ability to control and customize the input and output of networked beverage system 100 of FIG. 6 for integration with other systems. While a specific exemplary embodiment of a suitable server 130 has been provided above, those skilled in the art will recognize that many other suitable computers (with more or fewer features) may be substituted for the specific example provided herein within departing from the spirit and scope of the present invention.

Similar to data server 130, each custom beverage-dispensing machine 140 will also contain computer hardware and software (e.g., a CPU and memory, along with computer programs for the operation of the machine). This will allow each custom beverage-dispensing machine 140 to store data related to the operational aspects of the custom beverage-dispensing machine 140. For example, whenever a new drink recipe is created, it can be stored in database 223 and transmitted to each custom beverage-dispensing machine 140 for selection by a beverage consumer. In this fashion, the menu of custom beverages can be constantly updated.

Remote diagnostics may be provided to data server 130 by sensors (e.g., temperature sensors, noise sensors, accelerometers, etc.) contained within each custom beverage-dispensing machine 140. Any non-standard event can be transmitted to data server 130 via a wired or wireless network connection. If the network connection to data server is ever lost, the data for beverage consumption by each custom beverage dispensing machine 140 can be stored locally and then transmitted to data server 130 once the network connection has been restored. The software used to control the operation of each custom beverage dispensing machine 140 is an extension of beverage application 227 and the operation of each custom beverage dispensing machine 140 can be customized as desired.

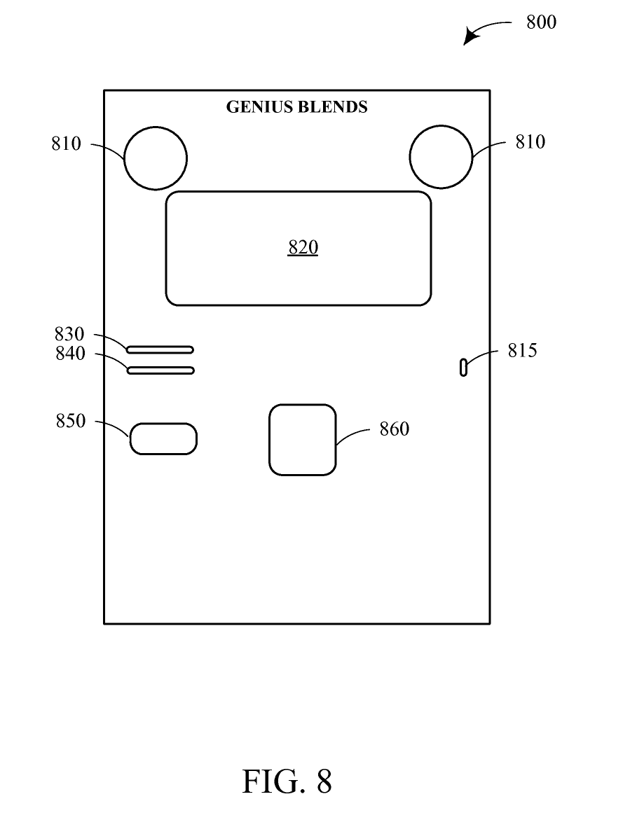

Referring now to FIG. 8, a front panel 800 suitable for a custom beverage-dispensing machine 140 used in conjunction with a custom beverage dispensing system in accordance with an alternative preferred exemplary embodiment of the present invention is depicted. As shown in FIG. 8, front panel 800 includes a pair of speakers 810, a USB port 815, a display screen 820, a credit card slot 830, a cash slot 840, a change receptacle 850, and a beverage access opening 860.

Speakers 810 are used to provide audio output for the beverage consumer. Various audio messages, music, and the soundtrack for videos displayed on display screen 820 may be output via speakers 820.

As previously explained, USB port 815 can be used to download and upload information to a mobile handheld device (e.g., MP3 player, cellular telephone, etc.). For example, customized audio and video content produced by speakers 810 and display screen 820 while a custom beverage is being prepared may be enjoyed by the beverage consumer while their custom beverage is being displayed and then the digital data file for the custom audio and video content may be downloaded to the beverage consumer's handheld device for later use and enjoyment.

Display screen 820, is an interactive screen, with a touch sensitive surface that can be used to interact with custom beverage dispensing machine 140 of FIG. 6. As previously explained, display screen 820 can display user instructions, menus, custom drink options, advertising messages, health and fitness videos, as well as other motivational and informational content.

Credit card slot 830 is capable of accepting credit card payments for purchasing custom beverages and for uploading money to a beverage consumer's user account to augment the account balance.

Cash slot 840 and change receptacle 850, are provided for those applications where it is desirable to accept cash for beverage purchases. The beverage consumer can insert cash into cash slot 840 and receive change, if any, from change receptacle 850.

Beverage access opening 860 is the opening where the beverage consumer can retrieve their custom beverage.

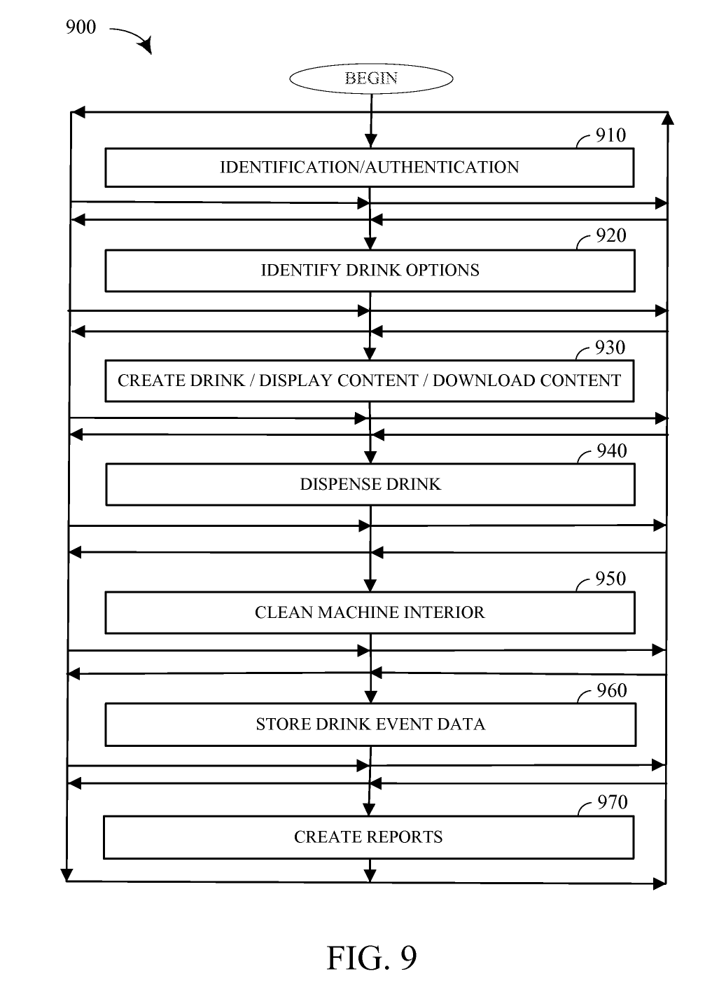

Referring now to FIG. 9, a method 900 for preparing and dispensing custom beverages is depicted. As shown in FIG. 9, the user will first log in or be identified at the custom beverage-dispensing machine (step 910). This may be accomplished by biometric identification (e.g. fingerprint pad) where the beverage consumer's fingerprint is captured and transmitted for verification prior to allowing the beverage consumer to access the functions of the custom beverage dispensing machine. Alternatively, the beverage consumer may access the touchscreen display and enter authentication credentials (e.g., user name, account number, password, etc.). Alternatively, a credit card may be used to authenticate the beverage consumer. For cash options, the identification/authentication step may be skipped.

Once the beverage consumer has been identified/authenticated, the beverage consumer will be presented with the custom drink options (step 920). The beverage consumer may select a pre-programmed drink option, a previously created custom drink option associated with their user account, or create a brand new “on the fly” custom drink by selecting from a variety of bases, ingredients, add-ins, supplements, vitamins, etc. The types of selections available to the beverage consumer will include powders (e.g., sports & nutritional supplements and powdered yogurt) as well as various liquid ingredients (water, purees, flavor syrups, and milk).

Next, while the selected custom drink is being created inside the custom beverage dispensing machine (step 930), content may be displayed to the beverage consumer via the touchscreen (step 930) and, if desired, the beverage consumer may download the content by connecting a handheld device to the custom beverage dispensing machine and storing the content on their handheld device for later use (step 930). The content may be customized for the beverage consumer, based on their demographics, user account preferences or it may be standardized content based on location, time of day, type of drink ingredients selected, etc. Advertising content, news, health and fitness information, as well as sports and entertainment information can be presented.

Once the custom drink has been mixed and blended, it can be delivered to the beverage consumer (step 940). After the custom beverage has been dispensed, the interior of the custom beverage-dispensing machine can be automatically cleaned, as necessary to ensure sanitary conditions (step 950). Next, the information related to the custom drink preparation and dispensing process is stored locally or remotely, or both (step 960). This data may include information such as day and time of custom drink preparation, type of ingredients selected for the custom drink, identification of the beverage consumer, location of the custom beverage dispensing machine, etc. By analyzing and aggregating this information, the owner/operators of the custom beverage-dispensing machine can more effectively and efficiently operate their business. They may also create reports (step 970) to further provide for operational efficiency. These reports may be provided electronically or via hard copy and may be provided to beverage users as well so that they can track their beverage consumption habits. Finally, beverage consumers may choose to set their user account preferences to share some or all of their beverage consumption information and habits via social media outlets (e.g., Facebook®, Twitter®, etc.). This will allow beverage consumers to share information such as custom drink recipes and new locations of custom beverage dispensing machines with other beverage consumers in their social networks. As shown in FIG. 9, each step in method 900 is independent of the other steps and it is possible to skip steps and to repeat certain steps, as necessary, in order to accomplish the desired goals.

Computer program code for carrying out operations for aspects of the networked beverage system may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that system and method for event tracking and messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A networked beverage system comprising:
a network;
a custom beverage dispensing machine connected to the network, the custom beverage dispensing machine comprising:
a touchscreen;
a plurality of ingredient hoppers;
at least one USB port; and
content displayed on the touchscreen during the creation of a custom beverage created from a plurality of ingredients selected from the plurality of ingredient hoppers, wherein the content is downloaded to a handheld device from the custom beverage dispensing machine via the USB port.

2. A method for creating custom beverages, the method comprising the steps of:
providing a custom beverage dispensing machine;
authenticating at least one beverage consumer at the custom beverage dispensing machine;
identifying a plurality of beverage options available at the custom beverage dispensing machine;
creating a custom beverage from the plurality of beverage options;
displaying content on a screen affixed to the custom beverage dispensing machine to the at least one beverage consumer during the creating of the custom beverage;
dispensing the custom beverage from the custom beverage dispensing machine; and
downloading the content from the custom beverage dispensing machine to a handheld device.
